(19) United States
(12) Patent Application Publication
(10) Pub. No.: US 2026/0332429 A1
(43) Pub. Date: Oct. 22, 2026

(54) MULTI-SEED HIERARCHY FOR NONCUSTODIAL COLD STORAGE

(71) Applicant: Unit 410, LLC, San Antonio, TX (US)

(72) Inventors: Robert WITOFF, San Antonio, TX (US); Drew ROTHSTEIN, San Antonio, TX (US); Grant SLAPE, San Antonio, TX (US); Alex MILLER, San Antonio, TX (US); Michael NELSON, San Antonio, TX (US)

(73) Assignee: Unit 410, LLC, San Antonio, TX (US)

(21) Appl. No.: 19/183,762

(22) Filed: Apr. 18, 2025

(51) Int. Cl. H04L 9/32; H04L 9/08

(52) U.S. Cl. CPC H04L 9/3242; H04L 9/0825; H04L 9/085; H04L 9/0869

(57) ABSTRACT

In some embodiments, a device and related method may execute action by using child control keys generated from a hierarchy of cryptographic seeds.

### SUMMARY

A cryptographic security architecture creates organized protection for digital information using various safeguards. The architecture may use seeds to create the keys that control access to protected information. The architecture may use various cryptographic tools including those to scramble data, verify message sources, and validate information. The architecture incorporates various cryptographic primitives including hash functions, digital signatures, and encryption algorithms to enforce confidentiality, integrity, and authentication. Implementation typically involves both technological components and procedural controls, with physical security measures protecting the most sensitive elements. The architecture often separates online and offline systems, employing hardware security modules and air-gapped devices to minimize attack surfaces. Furthermore, some systems may implement a master lock system. A master lock may be a high security authentication mechanism that protects a root seed or master key. Using a master lock may involve multiple authentication factors, such as complex passphrases, physical tokens, biometrics, or multi-party authorization to unlock seed operations.

A vulnerability in many cryptographic security architectures involves the concentration of trust in centralized key holders. Such an arrangement may introduce a service provider as a central point of failure. Moreover, a root seed faces several exposure vectors during operational use, even with careful security practices. For example, electromagnetic emissions, power consumption patterns, or acoustic signatures of devices handling the seed can leak cryptographic information to sophisticated monitoring equipment. Moreover, memory vulnerabilities create additional exposure risks when seeds are loaded into a device's working memory during action signing. The master lock creates additional vulnerability because it introduces a separate authentication layer that might be compromised through social engineering, coercion, insider threats, or implementation flaws, potentially exposing the root seed despite the operational security of the regular system.

Some embodiments may resolve such issues and other issues by using a seed and key hierarchy to hide the identity of a root seed used to derive downstream seeds or keys and then using the downstream values for day-to-day operations (e.g., only the keys generated from child seeds generated from a parent seed are used for day-to-day operations). Furthermore, some embodiments may establish a mechanism in which the one-time use operation keys are used and then deleted if certain criteria are satisfied, eliminating the need for a master-lock. Some embodiments may generate a child client control seed based on a client control seed associated with a client. For example, a client control seed could be a unique identifier for a client, and the child client control seed could be derived from this identifier to create a more specific control seed for a particular session or operation. Some embodiments may generate a child client control key by executing a message authentication code operation based on the child client control seed. For instance, the child client control key could be generated using a cryptographic algorithm that ensures the integrity and authenticity of the control seed. Some embodiments may generate a secondary root value based on the child client control key and a root seed. Some embodiments may execute an action by reconstructing a reconstructed version of the secondary root value based on an operation key associated with a received request and a set of shards associated with the root seed. For example, the operation key could be a cryptographic key used to decrypt data, and the set of shards could be pieces of the root seed stored across different servers. Some embodiments may execute the action based on the reconstructed version of the secondary root value. This could involve performing a secure operation, such as accessing encrypted data or executing an operation.

The technical benefits of performing operations described in this disclosure include enhanced security through hierarchical key generation, which reduces the risk of key compromise. The security architecture employs multiple layers of entropy generation and secret splitting among shard keys, increasing the likelihood that no single point of failure exists. This architecture involves both clients and a noncustodial service provider holding shards, enhancing the durability and resilience of the cryptographic system against potential losses or breaches. Additionally, implementations of some embodiments allow clients to maintain full control of encrypted associated data by using a client control seed. Furthermore, by using operation keys, which may be single-use and tied to individually specific operations, some embodiments may prevent the compromise of one operation from affecting the overall system. By destroying an operation key upon completion of an operation, some embodiments may increase the likelihood that an operation key is not reused or exploited.

Various other aspects, features, and advantages of the embodiments described in this disclosure will be apparent through the detailed description of the and the drawings attached. It is also to be understood that both the foregoing general description and the following detailed description are examples and are not restrictive of the scope of the invention.

### BRIEF DESCRIPTION OF THE DRAWINGS

FIG. 1 shows an example system for executing actions by providing operational access using child control keys generated from a hierarchy of cryptographic seeds, in accordance with one or more embodiments.

FIG. 2 shows a flowchart of a process for constructing a seed and key hierarchy used to effectuate actions, in accordance with one or more embodiments.

FIG. 3 shows a flowchart of a process for executing actions based on a root seed and a control seed, in accordance with one or more embodiments.

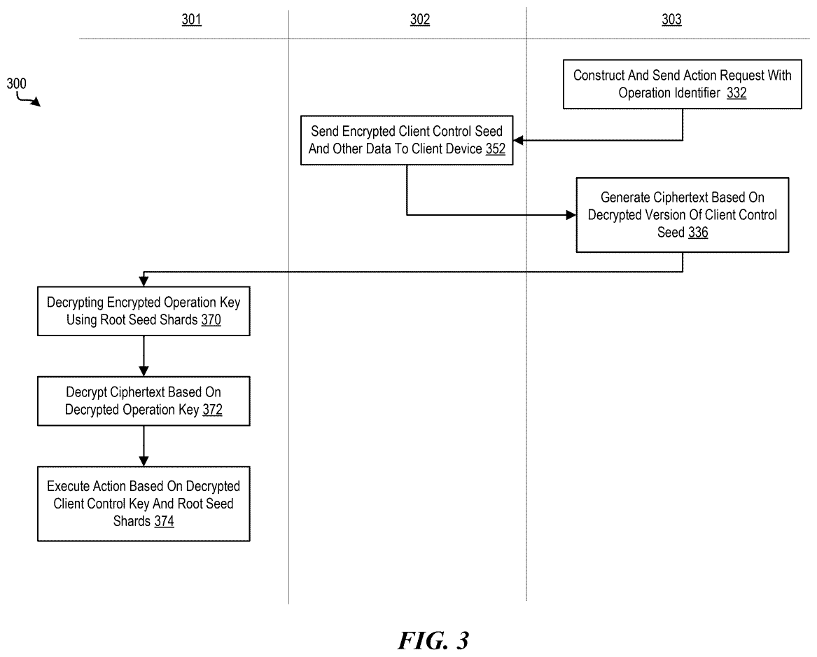

FIG. 4 shows an illustrative diagram of a key hierarchy, in accordance with one or more embodiments.

FIG. 5 shows an illustrative diagram for a digital noncustodial digital storage system, in accordance with one or more embodiments.

FIG. 6 shows an illustrative diagram for a data architecture of a key hierarchy, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

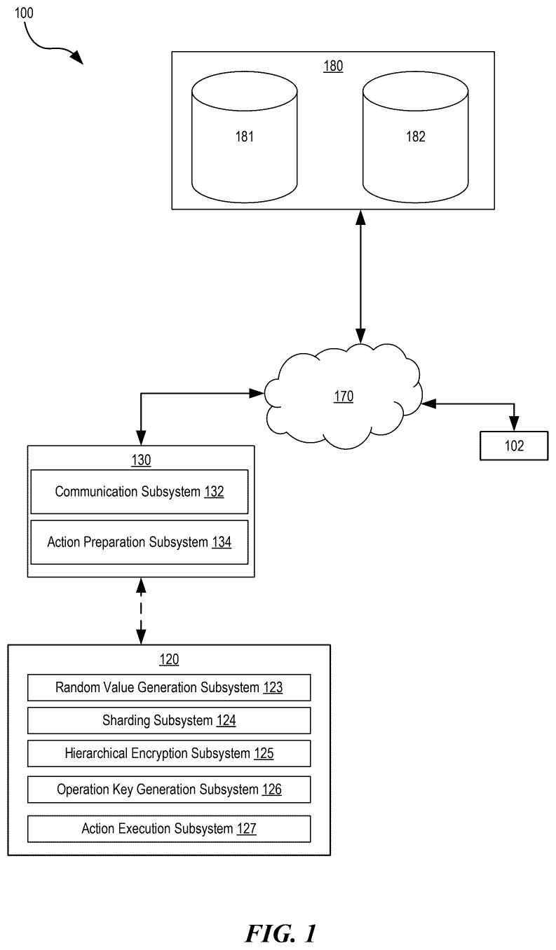

FIG. 1 shows an example system for executing actions by providing operational access using child control keys generated from a hierarchy of cryptographic seeds. A system 100 includes a client device 102 in communication with a server 130 via a network 170 (e.g., an internal network, the Internet, etc.).

In some embodiments, the system 100 may perform operations to effectuate noncustodial operations using a hierarchical architecture. Some embodiments may shard a root seed using a secret sharing algorithm and generate a plurality of root seed shards from the root seed. The secret sharing algorithm may be employed to distribute a root seed into multiple pieces or shards while maintaining the ability to reconstruct the original seed. For example, a computer system may use Shamir's Secret Sharing scheme to divide a 256-bit root seed into nine shards, where at least two of the nine shards are needed to reconstruct the original root seed. Some embodiments enhance security by cryptographically hashing a client control seed to generate a child client control seed, which is then used to create a child client control key through a hash-based message authentication code (HMAC). This process generates a secondary root value that is divided across multiple shards, making it more difficult for an adversary to compromise the root seed by obtaining just one shard. Some embodiments may then cryptographically hash a client control seed to generate a child client control seed. Some embodiments may generate a child client control key by executing an HMAC operation based on the child client control seed. Some embodiments may generate a secondary root value based on the child client control key and a version of the root seed. Some embodiments may reconstruct the secondary root value to process an action (e.g., a database action, executing a service or application, generating a file, etc.).

Some embodiments may cryptographically hash a client control seed associated with a client and generate a child client control seed that is mapped to vault data, such as a dataset including a vault seed and a vault key. For example, some embodiments may use a Secure Hash Algorithm (SHA) operation to hash values. For example, some embodiments may use a SHA-256 in a computer system to hash a unique client control seed used to determine a child client control seed that maps to a dataset for a vault including the vault seed and vault key for that vault. By applying hashing a first seed to form a second seed that is then used for downstream operations, some embodiments may increase the likelihood that the original client control seed remains confidential and tamper-proof. Some embodiments may generate a child client control key for an entity by executing an HMAC operation based on the child client control seed. Some embodiments may then generate a secondary root value based on the child client control key and a version of the root seed and process actions based on reconstructed secondary root values.

Some embodiments may shard a root seed using a secret sharing algorithm to generate multiple root seed shards and cryptographically hashing a client control seed to create a child client control seed that maps to vault data. Some embodiments may generate a child client control key for an entity by executing an HMAC operation based on the child client control seed. For example, a computer system using HMAC with SHA-256 to create a child client control key, where a child client control seed acts as the input to produce this authentication code, verifying the key's integrity and source. By generating the child client control key using an HMAC operation, some embodiments may enhance the authenticity and security of the cryptographic operations. Some embodiments may then generate a secondary root value based on the child client control key and a version of the root seed and process actions based on reconstructed secondary root values.

Some embodiments may shard a root seed, hash a first seed to generate a second seed, generate a first key based on the second seed, and generate a secondary root value based on the first key and a version of the root seed. Some embodiments may shard the root seed using a secret sharing algorithm to generate root seed shards. Some embodiments may cryptographically hash a client control seed to generate a child client control seed mapped to vault data. Some embodiments may generate a child client control key by executing an HMAC operation. Some embodiments may reconstruct the secondary root value to execute an action (e.g., an action causing a creation, update, or deletion to one or more records in a database) or another type of action. By generating a secondary root value, some embodiments may increase the layers of hierarchical security, increasing the likelihood that subsequent cryptographic operations use fresh or updated cryptographic material.

Some embodiments may construct a hierarchical architecture of seeds and keys used to operationally access one or more vaults to retrieve or update various types of data, such as personal identifiers, other seed values, key values, etc. Some embodiments may then receive a request to execute an action. In response to receiving the request, some embodiments may first reconstruct a version of the secondary root value based on an operation key and multiple root seed shards. For example, a computer system may reconstruct the secondary root value by reconstructing a root seed based on the multiple shards and then obtaining a decrypted operation key by decrypting an encrypted operation key using the reconstructed root seed. The computer system may then decrypt obtained ciphertext (e.g., by using the decrypted operation key) to obtain a client control key to reconstruct downstream data such as the secondary root value and execute an action based on the secondary root value. In such an operation, the execution of an operation requires a root seed, data derived from a client control seed (but not the client control seed itself), and an operation key. Thus, the client control seed itself is never jeopardized, but by using data derived from the client control seed, seed-holding client may reconstruct any related child seeds or keys for this operation.

The client device 102 may include one of various types of computer devices usable as a client-side device, such as a laptop, data terminal, mobile computing device, etc. The client device 102 may send requests, responses, or other messages to the server 130 that may require communication with other computing devices or other electronic devices. Additionally, the server 130 may include various types of computing units, such as physically separate servers, virtual nodes hosted on one or more physical machines, or nodes on a cloud computing system. Applications, services, or other operations may use data provided by the client device 102, the server 130, a set of databases 180 that includes a first networked database 181 and a second networked database 182, or an air-gapped computer system 120 that is isolated from other devices described in this disclosure. The set of databases 180 may include various types of databases, such as SQL databases, no SQL databases, graph databases, etc. In some embodiments, the air-gapped computer system 120 may perform one or more operations related to a random value generation subsystem 123, a sharding subsystem 124, a hierarchical encryption subsystem 125, an operation key generation subsystem 126, or an action execution subsystem 127. Furthermore, the server 130 may perform one or more operations related to a communication subsystem 132 or an action preparation subsystem 134. Additionally, it should be understood that the examples disclosed are non-limiting, such that subsystems and operations performed by one machine may instead be within another machine or performed by another machine.

In some embodiments, the air-gapped computer system 120 may be physically isolated from any network. The air-gapped computer system 120 may be a single device in some embodiments, the air-gapped computer system may include a plurality of devices in other embodiments. The air-gapped computer system may be provided with data necessary to effectuate an action to modify scores involving a first self-custody wallet and a second self-custody wallet and output a result indicating this action. After the air-gapped computing device executes the action, some embodiments receive a result of the action and then upload the action onto an internet-connected machine. The computer system may then upload the result of this action to an internet-connected machine for further processing or storage.

In some embodiments, the random value generation subsystem 123 may generate seeds, keys, or other data described in this disclosure. For example, the random value generation subsystem 123 may use a physics-based random number generator that is based on one or more physical phenomena to generate a random number, such as a thermal noise-based random number generator, radiation-based random number generator, etc. The random value generation subsystem 123 may generate a root seed, a client control seed, or other values described in this disclosure. Alternatively, or additionally, the random value generation subsystem 123 may generate random values that are used to produce seeds or keys. For example, the random value generation subsystem 123 may generate a first random value that is then hashed with a hashing algorithm, where the hashed output is then used as a root seed.

In some embodiments the sharding subsystem 124 may shard one or more values described in this disclosure. For example, the sharding subsystem 124 may shard a root seed that is generated using the random value generation subsystem 123. The sharding subsystem 124 may shard a root into multiple shares using various types of algorithms and store the shares into shards. For example, the sharding subsystem 124 may shard a root seed into nine shares and store each of the nine shares into a unique shard, where the shards may then be distributed into separate physical memory devices.

In some embodiments, the hierarchical encryption subsystem 125 may generate one or more seeds or keys based on a root seed or other initial value. In some embodiments, the hierarchical encryption subsystem 125 may cryptographically hash a client control seed associated with a client to generate a set of respective child client control seeds that are mapped to respective vault data comprising a respective vault seed and a respective vault key. For example, the hierarchical encryption subsystem 125 may use SHA-256 to hash a unique client control seed, resulting in a child client control seed that maps to a dataset for a vault associated with an entity, including the vault seed and vault key for that vault. It should be understood that the terms seed and key refer to respective relationships with each other, where a key described in this disclosure may be used directly to encrypt or decrypt data, and where a seed may be used as an entropy source used to derive more seeds or keys. Furthermore, the hierarchical encryption subsystem 125 may first hash a client control seed to generate a first hash value and then use the first hash value for additional hashing operations to determine child client control seeds, where the use of the first hash value in lieu of the client control seed directly may increase data security. The hierarchical encryption subsystem 125 may then generate a child client control key for the same entity by executing a HMAC operation based on the child client control seed. For example, the hierarchical encryption subsystem 125 may use HMAC with SHA-256 to create a child client control key, where the child client control seed acts as the input to produce this authentication code.

The hierarchical encryption subsystem 125 may generate a secondary root value based on the child client control key and a version of the root seed. For example, the hierarchical encryption subsystem 125 may perform an HMAC-SHA512 operation on a combination of a root seed and a client control key (e.g., concatenation, a sum, some other operation that relies on the value of both the root seed and client control key). The hierarchical encryption subsystem 125 may perform the HMAC-SHA512 operation to determine a secondary root value, which can then be or include downstream keys or other values used to effectuate actions such as an action involving score modification in one or more records or a self-custody wallet initialization. Alternatively, or additionally, the secondary root value may be used to generate downstream keys or other values used to effectuate actions.

The hierarchical encryption subsystem 125 may perform various cryptographic operations or other operations based on a root seed, a client control seed, or other values to generate a hierarchical arrangement of seeds and keys. In such a hierarchical arrangement, a root seed or client control seed may be used to generate other seeds and keys such that the other seeds and keys are exposed in the event of any downstream operations, leaving the root seed or client control seed safe. Furthermore, such a hierarchical arrangement permits noncustodial cold storage because an entity may have possession of both the root seed and client control seed while still relying on a noncustodial service provider to execute day-to-day operations for safety.

The operation key generation subsystem 126 may generate one or more operation keys used as a part of executing actions described in this disclosure. For example, the operation key generation subsystem 126 may generate an ed25519 private key that is generated from a random value, such as a random value generated by the random value generation subsystem 123. The operation key generation subsystem 126 may then hex encode these operation keys for storage. In some embodiments, the operation key generation subsystem 126 may produce operation keys in batches and assign the keys with unique names, such as a name that includes two Bitcoin Improvement Proposal 39 (BIP39) words separated by a dash. In some embodiments, a different operation key may be assigned for all possible names of a set of names within a confined namespace. For example, if the name is limited to being two BIP39 words separated by a dash, and since there are 2048 names in the BIP39 namespace, some embodiments may generate 4,192,256 operation keys (i.e., 2048\hat{ }2-2048 operation keys).

In some embodiments, when a user constructs an action and then sends a request for the action, some embodiments may then assign an unused operation key to the action. Once the action is completed, some embodiments may then delete the operation key associated with the action, making each operation key single use. By making an operation key single-use and generating these single-use keys in a single batch, and by securing client control seeds in a hierarchy that removes the need for client control seeds to be used directly, some embodiments may eliminate the need for a master-lock to control access to a root value. For example, in lieu of using a master-lock for future key generation from a root seed, some embodiments may rely on a first hash of a client control seed as an additional seed for downstream child seed or key construction.

The action execution subsystem 127 may execute an action based on an operation key, a root seed, and data derived from a client control seed. The operation key generation subsystem 126 may obtain ciphertext that includes a client control key that is encrypted with a public key generated by an operation key. The action execution subsystem 127 may then decrypt the ciphertext by (1) reconstructing a root seed by using root shards stored in a database or provided to the air-gapped computer system 120, (2) decrypt an encrypted version of an operation key by using the reconstructed root seed as a decryption key, and (3) decrypt the ciphertext by using the decrypted operation key as a decryption key to reconstruct the client control key from the ciphertext. The action execution subsystem 127 may then use the reconstructed version of the client control key to reconstruct downstream data generated with the client control key, such as a reconstructed version of secondary root data. For example, the action execution subsystem 127 may perform operations to retrieve a first decrypted client control key CCK1 and then use the first decrypted client control key CCK1 to, in combination with the reconstructed root seed, execute the action.

In some embodiments, the server 130 may perform network-related operations or other operations described in this disclosure. For example, the server 130 may store and retrieve encrypted data, encrypt or decrypt data stored in the set of databases 180 or other memory storage. The server 130 may also communicate with other computing devices described in this disclosure, such as the set of databases 180 or the client device 102. In some embodiments, the server 130 may be isolated from the air-gapped computer system 120 with respect to wired or wireless communication. In some embodiments, data transfer between the server 130 and the air-gapped computer system 120 may require the use of physical media (e.g., a secured USB storage device).

In some embodiments, the communication subsystem 132 may obtain program instructions, commands, parameters, values, or other data from the server 130 or the set of databases 180. For example, some embodiments may use the communication subsystem 132 to provide the server 130 with seeds, keys, encryption algorithm parameters, or other data from the set of databases 180 or the client device 102. Furthermore, operations performed by the client device 102 may use the communication subsystem 132 to send messages to the set of databases 180, the server 130, or another computing device described in this disclosure. For example, some embodiments may use the communication subsystem 132 to send encrypted keys obtained by the server 130 to the client device 102. Furthermore, some embodiments may use the communication subsystem 132 to communicate with one or more remote computing devices to offload some or all of the operations described in this disclosure. Additionally, some embodiments may use the communication subsystem 132 to receive data physical media (e.g., SD cards, external hard drives, hardware authentication devices, etc.).

In some embodiments, the communication subsystem 132 may obtain program instructions, commands, parameters, values, or other data from the server 130 or the set of databases 180. For example, some embodiments may use the communication subsystem 132 to provide the server 130 with seeds, keys, encryption algorithm parameters, or other data from the set of databases 180 or the client device 102. Furthermore, operations performed by the client device 102 may use the communication subsystem 132 to send messages to the set of databases 180, the server 130, or another computing device described in this disclosure. For example, some embodiments may use the communication subsystem 132 to send encrypted keys obtained by the server 130 to the client device 102. Furthermore, some embodiments may use the communication subsystem 132 to communicate with one or more remote computing devices to offload some or all of the operations described in this disclosure. Additionally, some embodiments may use the communication subsystem 132 to receive data physical media (e.g., SD cards, external hard drives, hardware authentication devices, etc.).

In some embodiments, the action preparation subsystem 134 may perform operations to store encrypted data for later use. For example, some embodiments may store a set of root seed shards for later operations to reconstruct a root seed or store an encrypted client communication seed for later client-side authentication operations. For example, the action preparation subsystem 134 may receive ciphertext that includes an encrypted client control seed from the client device 102, where the encrypted client control seed is encrypted by a user-provided passphrase. Thus, though the server 130 may be able to store the ciphertext the unencrypted form of the control seed is unavailable to the server 130 for further use. The action preparation subsystem 134 may perform other operations related to executing an action, such as a sending public key generated from an operation key generated by the server 130 to the client device 102. The client device 102 may then encrypt a child client control key with the public key to generate a ciphertext and send the ciphertext back to the server 130.

As described elsewhere in this disclosure, some embodiments may set up a hierarchical architecture for providing secure operations for a noncustodial cold storage system. In some embodiments, an air-gapped computer system (e.g., the air-gapped computer system 120) may generate the cryptographic keys and seeds used in this disclosure, such as shard keys, a root seed, or a client control seed. The air-gapped computer system 120 or some other device may create shard keys using various random number generation methods. For example, the air-gapped computer system 120 may generate nine shard keys, where six are assigned to a client entity and three are retained by a noncustodial service provider. The air-gapped computer system 120 may also generate a root seed that consists of 8192 bits of entropy using a Shamir split algorithm. Furthermore, the air-gapped computer system 120 may generate, as a client control seed, a BIP39 mnemonic phrase that may be exported bundled into client bundles, where a bundle may be or may include a physical or digital collection of keys. For example, the client control seed may be stored in an SD card that is also storing shards.

In some embodiments, once the keys and seeds are generated, an administrator or device may store the data on physical media, including smartcards and SD cards, which are then securely transported as client bundles and service provider bundles. In some embodiments, the client bundles may each contain two shard keys, where a minimum of three shard keys are necessary to reconstruct a root seed, ensuring no single bundle can independently recover the root seed. These bundles may then be shipped to the client, where the client may use a client device to validate all shards and perform an “Activation” action through the service provider's web portal in communication with a server system (e.g., the server 130).

In some embodiments, a web application hosted on a server (e.g., the server 130) may manage the assignment of bundles, registration of shards, and approval of operations. In some embodiments, the server 130 may store encrypted metadata and facilitate client actions by providing the data used to encrypt client control keys to operation keys. A client device, such as the client device 102, may interact with the system through the web application, where a user may scan a client control seed QR code and set up a secure passphrase. The client device 102 may then encrypt the client control seed using the passphrase as an encryption key, which may enable a user to authorize operations without exposing their keys.

Similarly, the execution of an action (e.g., a signing action, self-custody wallet initialization, etc.) involves coordinated roles for the air-gapped computer system 120, the server 130 and the client device 102. The client device 102 may initiate the process by having the user request an action through the web application. The client device 102 may create the action and assign it a unique operation identifier. The client device 102 may then proceed through an approval workflow defined by a set of approval rules associated with the user or an entity associated with the user. In some embodiments, the approval rules may include a rule requiring cryptographic approval from multiple authorized representatives indicated by the rules.

Once the action is approved, the client device 102 may authorize the action by providing the passphrase or hash of the passphrase to the server 130 via the web application. The client device 102 may decrypt the client control seed using this passphrase and then derive the corresponding client control key. The client device 102 may then encrypt the client control key to an operation key provided by the server 130 and received by the client device 102. The client device 102 may then transmit and store the encrypted client control key on the server 130.

The server 130 may hold the encrypted client control key until an administrator or automated system may transfer (e.g., via a physical memory device) the data to the air-gapped computer system 120. The air-gapped computer system 120 may then receive the client's authorization and retrieve the necessary operation key from the server 130. The air-gapped computer system 120 may then use the operation key to decrypt the client control key. Concurrently, the air-gapped computer system 120 may recover the root seed from the stored shards within the secure facilities. The air-gapped computer system 120 may then combine the root seed and the decrypted client control key to derive the required cryptographic material, such as an entity cryptographic key or a self-custody wallet seed, necessary for executing the action.

In some embodiments, the air-gapped computer system 120 may perform the action requested by the client device 102 securely within the environment of the air-gapped computer system 120. The action may involve signing an operation, generating cryptographic keys, or other sensitive operations. Once the action is complete, the air-gapped computer system 120 may load the result onto a secure physical medium, where a person or computer system may transfer the data back to the server 130 for client access. The air-gapped computer system 120 may then destroy any used operation keys to prevent any reuse, preserving the integrity and security of the system.

It should be understood that while some embodiments may execute actions using an air-gapped computer system, some embodiments may execute actions using circuitry and applications within a hardware security module (HSM) that provides additional protection for key management. For example, the HSM may validate that an approval policy is satisfied before executing the operation with a key. In another embodiment, circuitry or applications used to execute an action may be integrated into a decentralized network node configuration, where distributed consensus mechanisms are employed to verify and execute operations. For example, in lieu of using an air-gapped computer system, operations described as being performed by an air-gapped computer system his disclosure may instead be performed by a plurality of networked computers. In some embodiments, each computer of the plurality of networked computers may have access to shares of a root key, with multiple computers of the plurality of networked computers coming to a consensus before executing an operation. Furthermore, some embodiments may be configured as a virtualized service within a secure enclave environment, such as one using trusted execution environments (TEEs) to increase the likelihood that sensitive computations are securely isolated from the host operating system.

### Flowchart

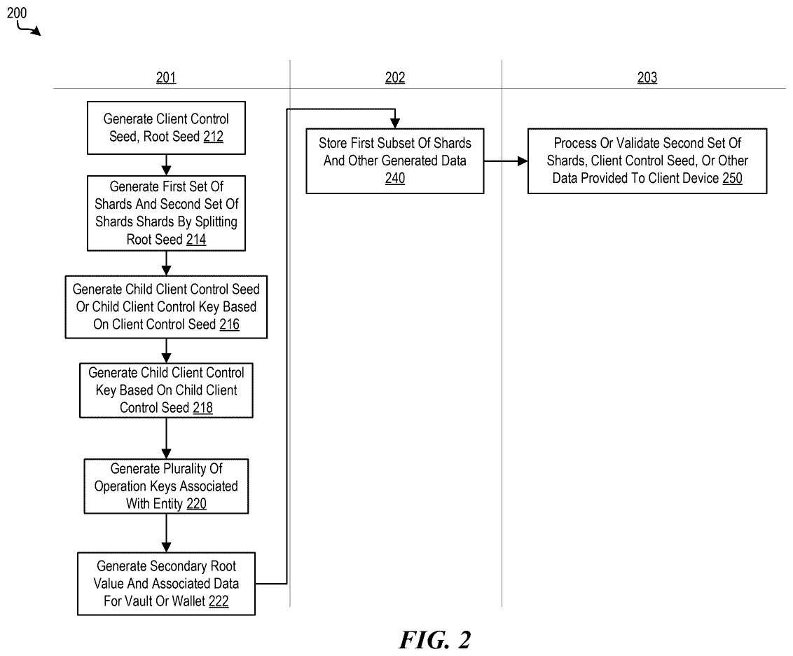

FIG. 2 shows a flowchart of a process for constructing a seed and key hierarchy used to effectuate actions, in accordance with one or more embodiments. The process 200 is shown as a swim lane flowchart, where a column 201 may represent operations performed by an air-gapped computer system that is isolated from other networks, a column 202 may represent operations performed by a server system that is connected to one or more networks, and a column 203 may represent operations performed by a client computer system. It should be understood that descriptions of an operation being performed by a system are exemplary and non-limiting, such that operations described as being performed by one system may instead be performed by another system unless described otherwise, including a system not depicted in the flowchart for the process 200. For example, in some embodiments, operations described by block 212 may be performed by an air-gapped computer system represented by operations in column 201 or instead be performed by a server system.

Some embodiments may generate a client control seed or a root seed, as indicated by block 212. Some embodiments may perform operations indicated by block 212 using an air-gapped computer system represented by column 201. A root seed may be or may include a sequence of values used to generate further operations. For example, a root seed may be or may include 8192 bits of entropy that is used, sometimes in conjunction with a client control seed, to derive other keys in the system. It should be understood that a root seed may include other amounts of data. For example, the root seed may include 4096 bits of entropy blended from two sources, such as a physics-based random number generator and an algorithmic random number generator.

Similarly, a client control seed may be or may include a sequence of values to generate keys used for further operations. For example, a client control seed may be or may include 128 bits of entropy, such as one represented as a BIP39 mnemonic phrase. For example, a client control seed may be or include a 256 bits sequence of words (e.g., BIP39 words). In some embodiments, the client control seed may be stored in a visual format, such as a barcode or a QR code. Alternatively, or additionally, some embodiments may store values derived from the client control seed (e.g., a first hash value used to derive child seed values or the child seed values themselves). In some embodiments, the client control seed may be or may include a mnemonic phrase, where a client root may then be derived from the mnemonic phrase. For example, some embodiments may determine a client root by hashing (e.g., via a SHA-256 hashing operation) the client root or a value based on the client root (e.g., “client_root_mnemonic+129”).

Some embodiments may generate a client control seed or a root seed using various methods. For example, some embodiments may use a physics-based random number generator on an SD card or random number generator function to generate a first random value to use as a root seed or use to determine a root seed. Some may also use other types of random number generators to generate a root seed, such as by using a random number generator (RNG) algorithm (e.g., ChaCha20, Fortuna, or Hash-based Message Authentication Code Deterministic Random Bit Generator (HMAC-DRBG), etc.).

Some embodiments may generate a first set of shards and a second set of shards by splitting the root seed, as indicated by block 214. Some embodiments may perform operations indicated by block 214 using an air-gapped computer system represented by column 201. Some embodiments split the root seed into a first set of shards assigned to noncustodial service provider, such as a noncustodial server system represented by the column 202 and a second set of shards assigned to a client entity, such as a client computer system represented by the column 203. Some embodiments may split the root seed by applying a secret sharing algorithm to the root seed. Various types of secret sharing algorithms may be used. For example, a computer system may split a root seed using algorithms such as Shamir's Secret Sharing, Blakley's Secret Sharing, or threshold schemes that divide a seed into parts, distribute them amongst participants, and require a minimum number of parts for reconstruction (e.g., at least two shards to reconstruct the seed). Some embodiments may store the first set of shards in a set of physical key materials (e.g., a set of smartcards, another set of hardware authentication devices, etc.) or a set of data stores without storing the second set of shards in the set of physical key materials or the set of data stores. Furthermore, it should be understood that, in some embodiments, seeds may be strictly stored in physical key materials without storing the keys in a database or another type of electronic data store. Various numbers of shards may be generated, such as 2 shards, 4 shards, 5 shards, 7 shards, 9 shards, or some other number of shards. Some embodiments may assign an uneven number of shards to different entities. For example, some embodiments may use a secret sharing algorithm to generate 9 shards from a root seed. Some embodiments may separate the generated shards into (i) a first set of shards that includes 3 shards and is assigned to a noncustodial service provider and (ii) a second set of shards includes 6 shards and be assigned to a client entity. For example, some embodiments may generate shares of a root seed using Shamir's Secret Sharing algorithm and store the share in a shard key, such as an EdDSA with Curve25519 Gnu Privacy Guard (GPG) key. Some embodiments may export some or all of the generated shards onto a set of security key bundles, such as a bundle that includes three smartcards that contain the same key for redundancy.

As described elsewhere in this disclosure, shards may be distributed amongst multiple entities, such as authorized representatives of the provider, authorized representatives of the client, or trusted third parties. For example, some embodiments may split a root seed using a (k, n) threshold scheme, where a minimum “k” of “n” shares may be decrypted or combined to reconstruct a root seed. For example, if k=3 and n=9, and two shards are provided to three individuals (e.g., the client, the provider, and a third party); then any two individuals may come together to reconstruct the root key, whereas if k=2, then any single individual may recover the root seed alone using only their shards. In some embodiments, both a client and a noncustodial service provider are provided sufficient shards to independently recover the root seed (i.e., either the provider or the client may recover the root seed). This configuration may allow a client to access the root seed, permitting the client to employ both the root seed and the client control seed to recover root values or associated data (e.g., entity keys). Alternatively, some embodiments may be configured to assign the provider a first set of the shards and the client a second set of the shards, where both sets are needed to recover a root key, and where the client and the provider cooperate to reconstruct a root key. Such configurations may be selected to improve auditability and increased control. For example, such configurations may provide a noncustodial computer system with the opportunity to independently verify that an approval policy is satisfied before authorizing an action.

As described elsewhere in this disclosure, some embodiments may generate a reconstructed version of a root seed by reconstructing the root seed using at least two shards. For example, some embodiments may generate a reconstructed version of a root seed using two shards from a first set of shards stored on a server, two shards from a second set of shards provided by a client device or otherwise previously stored on a client device, or one shard from the first set of shards and one shard from the second set of shards. Some embodiments may then use the reconstructed shards as appropriate.

Some embodiments may generate a set of child client control seeds based on a client control seed, as indicated by block 216. Some embodiments may perform operations indicated by block 216 using an air-gapped computer system represented by column 201. Some embodiments may use a client control seed to derive a first hash value and then use the first hash value as a foundational seed for one or more child client control seeds. For example, after obtaining a client control seed “CCS,” a computer system may apply an SHA-256 algorithm to CCS to obtain the hash value “CCS0.” The computer system may then generate a series of child seeds corresponding with entities mapped to the entity values “1,” “2,” and “3” by applying SHA-256 algorithms or other hashing algorithms on CCS0 to generate the child seeds “CCS1,” “CCS2,” and “CCS3.” A child client control seed may be treated as a higher-level seed with respect to a seed hierarchy that places the client control seed at a lower level. In some embodiments, a child client control seed may correspond with an entity, such that each respective child client control seed of a set of child client control seeds corresponds with a different respective entity associated with a group controlling the different entities (e.g., a larger entity controlling the different entities).

In some embodiments, in order to limit the total entropy loss associated with multiple constructions of child seeds from parent seeds, some embodiments may implement a threshold that limits the number of keys to be constructed. Some embodiments may determine whether a current count of child client control seeds exceeds a threshold and, based on a result showing that the count does not exceed the threshold, generate an additional child client control seed based. For example, a computer system may determine a result that indicates that generating an additional child seed from a root seed would result in a total count of 21 child seeds, which is less than a threshold of 32 child seeds. In response, the computer system may then generate the additional child client control seed. It should be understood that other threshold values are possible, such as a limit of 8 child client control seeds, 16 child client control seeds, 32 child client control seeds, etc. For example, some embodiments may limit the total count of child client control seeds constructed from a client control seed to be equal to or less than 64 child client control seeds.

Some embodiments may generate a child client control key based on the child client control seed, as indicated by block 218. Some embodiments may perform operations indicated by block 218 using an air-gapped computer system represented by column 201. Some embodiments may determine a client control key for an entity. For example, a client control key may include 256 bits of entropy represented as a sequence of numbers or letters. Furthermore, in some embodiments, a child client control key constructed from a child client control seed associated with an entity may thus be associated with the same entity. For example, some embodiments may apply a function that includes the operation ‘CCK_410=hmac.NewSHA256(byte(CCSi0+“−21”))’, where hmac. NewSHA256 is an method that performs an HMAC-SHA256 operation on a byte conversion of the value ‘CCSi0+“−21”’, and where CCSi0 is an entity-associated child client control key.

In some embodiments executing a message authentication code operation, such as an HMAC operation, may include determining an intermediate value based on the child client control seed and an index associated with an entity associated with the child client control seed. For example, some embodiments may be instructed to generate a key for an entity associated with the identifier “59.” In response, some embodiments may determine an intermediate value “Intermed_val” as the combination of a child client control seed and the value “59” (e.g., a concatenation of the seed and the text “59.”). Some embodiments may then execute an SHA-256 function on “Intermed_val” to determine a hash value and apply an HMAC function (or another message authentication code function) on the resulting hash value to determine an entity-specific child client key.

Some embodiments may generate a key fingerprint (“CCKF_i”) for a key when generating the key. For example, when generating a child control key, some embodiments also construct a child control key fingerprint based on the child control key. For example, a computer system may generate a first key “1234567890ABCDEF1234567890ABCDEF” and then construct a child control key fingerprint seed “1234.” Some embodiments may use other methods of constructing a fingerprint, such as using SHA-1 hashing. For example, some embodiments may generate a first key fingerprint “4B227777D4DD1FC61C6F884F48641D02B5E62D5D” derived from the first key using SHA-1 hashing on the first four digits of the first key. After generating a fingerprint, some embodiments may then use this fingerprint to validate or authenticate one or more keys. For example, a computer device may provide the child control key fingerprint to a client device for client-side validation of child control keys constructed by the client device.

Some embodiments may generate batches of child seeds or child keys. For example, some embodiments may first hash an original client control key to generate a first hash value CCS0. Some embodiments may then derive N client control keys using the first hash value, where N may be any number less than 2\hat{ }-1. For example, some embodiments may derive a batch of 15,000 client control keys using CCS0. Some embodiments may then construct a corresponding set of fingerprint values CCKF_i, where these fingerprint values may then be stored in external memory devices (e.g., devices sent to a client) or stored in a server-side database for downstream verification that a client has provided the correct key values.

Some embodiments may generate a plurality of keys and fingerprints for those keys during an initialization operation. For example, some embodiments may generate hundreds or thousands of child client control seeds, client control keys, and fingerprints based on a single client control seed. Some embodiments may then store the fingerprints or other public key associated with a generated seed or key in a database for later authentication or other downstream operations.

Some embodiments may generate a plurality of operation keys, as indicated by block 220. Some embodiments may perform operations indicated by block 220 using an air-gapped computer system represented by column 201. As described elsewhere in this disclosure, some embodiments may generate operation keys to use as keys for one or more operations, such as single-use keys for executing one operation. Some embodiments may generate these keys in bulk and destroy a key after the operation using the key is completed. For example, a computer system may have a plurality of operation keys, and a corresponding plurality of public keys, associated with the plurality of operation keys. Some embodiments may upload generated public keys to a database. Furthermore, some embodiments may involve obtaining a request and, in response, retrieving an operation key of the plurality of operation keys based on the request. For example, a computer system may obtain a request to effectuate an action and, in response, retrieve an operation key from a database for use to encrypt a child control key for the operation. As described elsewhere in this disclosure, some embodiments may then destroy the operation key in a database after performing the action, where destroying the operation key may include deleting the operation key, overwriting the operation key (e.g., overwriting with junk data), etc. For example, an air-gapped computer system may delete an operation key and a corresponding public key from memory after successfully executing an action using the operation key. Similarly, after the result of the action is provided to a server to update the server with the result, the server may delete local memory or other memory (e.g., a distributed set of databases) to delete the operation key and the corresponding public key from memory. Such destruction may prevent a services provider entity or other entity from performing further operations using the same operation key, thus increasing the security and auditability of data updates.

Some embodiments may receive a previous operation request from a client device that was encrypted with a lost operation key. Some embodiments may then validate whether the lost operation key is absent from the set of currently valid operation keys. Upon this confirmation, the system may notify the client device that the request associated with the lost key will not be executed. For example, a computer system may obtain an operation request linked to a missing operation key from a client device, check the non-existence of this key in the designated operation keys, and then respond to the client device that the operation request cannot be fulfilled.

Some embodiments may generate a secondary root value and associated data for a vault based on the child client control key and the root seed, as indicated by block 222. Some embodiments may perform operations indicated by block 222 using an air-gapped computer system represented by column 201. Some embodiments may generate a secondary root value and data associated with the secondary root value for a vault using a Password-Based Key Derivation Function (PBKDF) algorithm. For example, some embodiments may use a combination of a root seed and a client control key as inputs for a PBKDF2 algorithm to determine secondary root values. A vault may be derived from entropy that is itself constructed from a client control key and a root seed. For example, a vault for entity X may be derived from a secondary root value V_x, where V_x may be 512 bits of entropy that is generated by performing one or more operations involving a child key and a root seed. For example, some embodiments may determine a secondary root value V_x by performing an HMAC-SHA512 operation on a combination of a root seed and a client control key. Using this secondary root value V_x, a computer system may then be used to generate downstream keys or other values used to effectuate actions, such as an action, a self-custody wallet initialization, etc.

Some embodiments may reconstruct a root seed from at least some of the multiple shards before using the root seed to generate the secondary root value. For example, a computer system may generate a secondary root value based on a child client control key and at least some of the multiple shards by first reconstructing a root seed from two of the multiple shards. The computer system may then use the root key in combination with the child client control key to generate the secondary root value.

The secondary root value may include one or more various types of values usable as vault data or be used to generate one or more various types of values usable as vault data. Vault data may include data such as a self-custody wallet seed usable to generate one or more self-custody wallets, a GPG key, or other values used to characterize and define a vault. For example, a 512-bits vault may include a 256-bits ed 25519/cv25519 GPG key and a 256-bits vault seed value. Some embodiments may use these values for further downstream operations. For example, some embodiments may use the generated GPG key to encrypt various types of data when authenticating operations related to a vault. Additionally, or alternatively, some embodiments may generate a self-custody wallet seed by using the vault seed value as an input for a PBKDF2 function. For example, some embodiments may generate, as a self-custody wallet seed, 256 bits of unique entropy that is formatted as a BIP39 mnemonic.

In some embodiments, generating the secondary key may include generating a first version of a secondary key based on the secondary root value, where this secondary key is usable to initialize a self-custody wallet or vault using this secondary key. As described elsewhere in this disclosure, some embodiments may then execute an action which involves re-generating a second version of the secondary key based on a reconstructed version of the secondary root value and using this second version of the secondary key to execute the action. For example, a first computer system may determine an initial instance of a secondary vault key by applying the SHA-256 hash function to the secondary root value.

In some embodiments, operations to generate the secondary root value may be performed in a secure computing environment that is isolated from other computing systems. Furthermore, operations to generate values derived from the secondary root value may also be performed in the secure computing environment. For example, an air-gapped computer system may generate a first secondary root value associated with a first entity. The air-gapped computer system may then use a first portion of the secondary root value as a GPG key to encrypt or decrypt data into a ciphertext database, where the ciphertext database may be identified by or otherwise associated with the first entity. Furthermore, the air-gapped computer system may use a second portion of the secondary root value for use as a secondary root seed and construct a set of self-custody wallet identifiers based on values associated with a target wallet and the secondary root seed. For example, some embodiments may apply another SHA-256 operation to a secondary root seed for an entity associated with the secondary root seed and multiply the result of the hashing operation with an index value mapped to a target entity. Some embodiments may then use the products as a self-custody wallet identifier.

Technical benefits of this method include increased security by ensuring that the secondary vault key is derived dynamically, minimizing the risk of key exposure during the process. Additionally, regenerating the secondary vault key during each operation request ensures the resilience and integrity of the cryptographic system, making it significantly more challenging for unauthorized entities to recreate or misuse the cryptographic keys. This process of dynamically generating and re-generating keys reduces the likelihood of key compromise and enhances the overall robustness of the cryptographic system, particularly against targeted attacks.

Some embodiments may store the first subset of shards and other generated data, as indicated by block 240. Some embodiments may perform operations indicated by block 240 using a server system represented by column 202. Some embodiments may store shards such that the individual shards in one or more server-accessible memory. Some embodiments may further store other data described in this disclosure in server-accessible memory, such as operation keys generated using operations described for block 220. For example, some embodiments may store three shards from a set of nine shards in an encrypted database, where three shards may be sufficient to reconstruct a root seed. It should be understood that some embodiments may use a sharding method that permits reconstruction with some other minimum number of shards, such as a minimum of two shards or a minimum of five shards.

Some embodiments may process or validate the second set of shards or the client control seed, as indicated by block 250. Some embodiments may perform operations indicated by block 250 using a client system represented by column 203. A user may obtain a physical data bundle that includes shards (e.g., shards stored in SD cards). The user may then use a client device represented by the column 203 to validate the received data. For example, the user may validate each received shard with an activation operation by executing a signing action using operations described elsewhere in this disclosure, such as one or more operations described for the process 300. Furthermore, a user may use the client device to process a client seed. For example, a user may log into an online application using the client device and scan a client seed QR code (e.g., a QR code provided in a physical bundle). The client device may then generate a ciphertext that includes an encrypted version of the client control seed and send the ciphertext to a server system for storage. For example, the client device may send the ciphertext to a server system represented by the column 202. As a part of processing received data, some embodiments may use the client device to perform operations, such as encrypting client control seeds with a user-provided passphrase, describing rules associated with execution operations, etc.

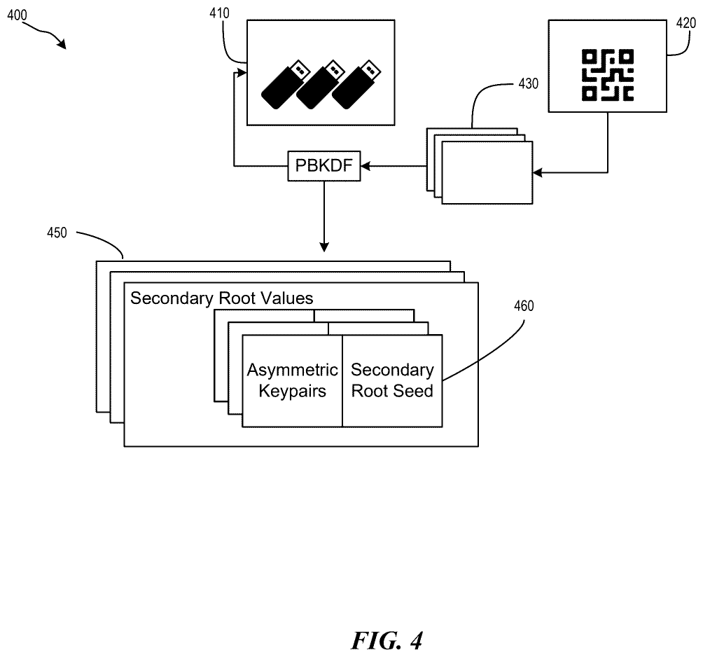

FIG. 4 shows a flowchart of a process 300 for executing actions based on a root seed and a control seed, in accordance with one or more embodiments. The process 300 is shown as a swim lane flowchart in which a column 301 represents operations performed by a first computer system (e.g., an air-gapped computer system that is isolated from other networks), column 302 represents operations performed by a second computer system (e.g., a server system that is connected to one or more networks), and column 303 represents operations performed by a third computer system (e.g., a client computer system). It should be understood that descriptions of an operation being performed by a system are exemplary and non-limiting, such that operations described as being performed by one system may instead be performed by another system unless described otherwise, including a system not depicted in the flowchart for the process 300. For example, in some embodiments, operations described by block 352 may be performed by an air-gapped computer system represented by operations in column 301 or instead be performed by a server system.

Some embodiments may construct and send a request to execute an action, as indicated by block 332. Some embodiments may perform operations indicated by block 332 using a client device represented by column 303. In some embodiments, a user may construct an operation in an application dashboard displayed on a display screen of a client device, where the operation is assigned a unique ID. Some embodiments may provide a user with options to define an approval workflow that must be completed before the operation can be executed. For example, a client computer system may enforce approval rules through a web application (e.g., determining that a user is limited in some way). The computer system may perform approvals cryptographically using a mobile app installed on one or more devices of the computer system or one or more devices in communication with the computer system.

Some embodiments may send an encrypted client control seed to a client device, as indicated by block 352. Some embodiments may perform operations indicated by block 352 using a server device represented by column 302. Some embodiments may send the encrypted client control seed after receiving a request, such as the request described for operations for block 332. Furthermore, as described elsewhere in this disclosure, after detecting that an operation key was used to execute an action, some embodiments may delete the operation key from memory.

Some embodiments may generate ciphertext based on a decrypted version of the client control seed, as indicated by block 336. Some embodiments may perform operations indicated by block 336 using a client device represented by column 303. Some embodiments may decrypt an encrypted client control seed to obtain a decrypted client control seed. Some embodiments may decrypt the encrypted client control seed with a passphrase. As described elsewhere in this disclosure, a server system may store or have access to an encrypted version of a client control seed that is encrypted with a passphrase. Though a server system may store an encrypted seed, the server system itself may not have access to the passphrase, rendering the server unable to use the client control seed and thus having no custody over the client control seed. Some embodiments may then generate a child control seed based on the client control seed and then determine a child client control key based on the child control seed.

After obtaining the decrypted client control seed, some embodiments may fetch a public key for an operation key (e.g., a unique operation key) from a server system (e.g., the server system represented by column 202). Some embodiments may then generate ciphertext by encrypting the generated client control key to the operation key. For example, a client system may generate ciphertext by using an AES-256 method to encrypt the client control key using the operation key as the encryption key for the encryption operation. It should be understood that encrypting a first key to a second key may include encrypting the first key by using a public key generated from the second key as the public key for the encryption operation.

Some embodiments may decrypt the encrypted operation key using root seed shards, as indicated by block 370. Some embodiments may perform operations indicated by block 336 using an air-gapped computer system represented by column 301. Some embodiments may obtain an operation identifier associated with the received request and select the operation key based on the operation identifier. Some embodiments may involve retrieving a public key associated with the operation key based on the operation identifier. For example, a computer system may obtain an operation identifier related to a received request (e.g., self-custody wallet generation) and may select an appropriate operation key corresponding to this identifier. Some embodiments may then send the operation key (e.g., an encrypted version of the operation key) to a client device. The client device may then construct ciphertext by encrypting a child client control key to the operation key.

Some embodiments may decrypt the encrypted operation key using root seed shards, as indicated by block 372. Some embodiments may perform operations indicated by block 372 using an air-gapped computer system represented by column 301. Some embodiments may receive ciphertext constructed by encrypting a child client control key to the operation key and execute an operation based on the ciphertext. In some embodiments, a computer system, such as an air-gapped computer system, may be provided with an encrypted version of the operation key (e.g., via physical media such as an SD card). Some embodiments may then decrypt the operation key using root seed shards, such as a first set of shards stored on a server, and then use the decrypted OK to decrypt the ciphertext.

Some embodiments may execute an action based on a reconstructed version of the secondary root value, as indicated by block 374. Some embodiments may perform operations indicated by block 374 using an air-gapped computer system represented by column 301. Executing an action may include using various data described in this disclosure, such as a root seed, a client control key, and an operation key. Some embodiments may use decrypted ciphertext in combination with the root seed to generate a reconstructed version of the secondary root value, such as a vault root, using the operation described in this disclosure.

Executing the action may involve operationally accessing one or more various types of data stored in ciphertext or decrypted by data obtained based on the ciphertext. With a reconstructed secondary root value, some embodiments may execute an action using an entity-level GPG key or a self-custody wallet seed. For example, some embodiments may execute a message signing based on reconstructed secondary root value and an entity-level GPG key. For example, an air-gapped computer system represented by column 201 may execute an operation using a GPG key by preparing a data structure containing details like recipient, amount, and timestamp. The computer system may then hash this data using SHA-256 or another cryptographic algorithm to create a unique digital fingerprint and use the private GPG key to sign this hash to create a digital signature to indicate authorization. The computer system may then verify this signature using the corresponding public GPG key to authenticate that the computer system authorized the operation. The complete operation package may then be relayed to a network connected device, such as a server system represented by column 302. For example, an administrator may first store the operation package on a physical memory device (e.g., an SD card) and insert or otherwise connect the physical memory device to the server system. The server system may then process this operation data by validating the operation data and then updating a distributed ledger based on the operation data. It should be understood that the above example is non-limiting and that various other types of operational access to data is possible to effectuate other types of actions, such as executing a smart contract or another distributed application, initializing or re-allocating a computing resource (e.g., memory, processor resources, etc.), executing a database action, etc.

FIG. 4 shows an illustrative diagram of a key hierarchy 400, in accordance with one or more embodiments. The key hierarchy 400 includes a root seed 410. In some embodiments, the root seed 410 may be referred to as a root seed. The root seed 410 may include sufficient entropy to securely derive the child keys 430, secondary root values 450 (which may include or be used to derive values such as entity keys 460).

In some embodiments, the key hierarchy 400 includes a client control seed 420. In one embodiment, the client control seed 420 may be stored in a plurality of bundles on physical storage media (such as a QR code, SD card, metal card with keys inscribed, or other suitable storage media), and may be erased from a noncustodial service provider's system (e.g., erased from an air-gapped computer system used to create the client control seed 420) after initialization of the key hierarchy 400. As described elsewhere in this disclosure, some embodiments may generate the client control seed 420 by gathering entropy (e.g., 128 bits of entropy). In some embodiments, the client control seed 420 may be represented as code used to deterministically recover key material. For example, some embodiments may store the client control seed 420 in a BIP39 form and may encode entropy in a multiple of 32 bits as a mnemonic phrase.

In some embodiments, the client control seed 420 may be stored in a set of client-accessible data bundles, such as a set of SD cards. In some embodiments, the key storage may be arranged such that any entity that holds a single bundle may access the client control seed 420. Alternatively, in some embodiments, the client control seed 420 may only be stored on a subset of bundles or be split across a plurality of bundles via a (k, n) threshold scheme.

Some embodiments may transform the client control seed 420 to an entity-specific child seed before use. For example, some embodiments may determine an entity-specific child seed by hashing the client control seed with a modifier (e.g., client control seedX=SHA256 (client control seed+“−”+X), where “X” is an integer mapped to an entity, where “client control seed” is a client control seed, and where SHA256 is an function that performs SHA-256 hashing operations). This transformation allows subsequent cryptographic operations to derive subsequent entity-specific seeds and entity-specific keys from client control seed. This configuration preserves the ability to determine additional, independent client control keys that may be used to enable future use cases or upgrade paths. For example, a future upgrade path may use client control seed2 to derive a plurality of keys that are independent from key hierarchy 400 but may still be derived from the root seed 410 and the client control seed 420.

The key hierarchy 400 includes the child keys 430. Some embodiments may generate the child keys 430 based on the client control seed 420. In some embodiments, the child keys 430 may also be referred to as client control keys. Some embodiments may generate the child keys 430 based on the client control seed 420 by first generating child control seeds and then using the child control seeds to generate the child keys 430. Some embodiments may then distribute the child control seeds and the child keys without moving or using the unencrypted forms of the client control seed 420.

The key hierarchy 400 includes the secondary root values 450. In this embodiment, client control keys may be used to derive secondary root values 450, where an entity possessing secondary root values 450 may be able to access the secondary root values 450, effectuate actions with the secondary root values 450, and perform operations related to the secondary root values 450. For example, the child keys 430 may include a first child key CTᵢ that is determined based on a combination of the client control seed 420 and the entity identifier i as follows: “CTᵢ=SHA256(S+i).”

The key hierarchy 400 includes entity keys 460. The entity keys 460 may be employed to perform sensitive operations, such as signing messages, decrypting ciphertexts, authorizing operations for self-custody wallets or other digital assets (such as Bitcoin wallets, Ethereum smart contracts, votes on decentralized autonomous organization (DAO) governance, or other digital assets or entities that are accessible via digital signature or other cryptographic operations employing entity keys 460). For example, asymmetric keypairs may be derived from an entity key (i.e., by employing 64 bytes of entropy to derive a cv/ed25519 GPG keypair). Alternatively, a plurality of self-custody wallets may be generated using the entropy (where a wallet may be a key that can authorize operations involving a given private key). Some embodiments may derive the entity keys 460 using a hierarchical deterministic wallet derivation method (e.g., a method defined in BIP32). Some embodiments may derive the entity keys 460 by combining a secondary root value of the secondary root values 450 with a plaintext wallet identifier and then hashing the combination to derive entropy that may be used as a wallet key. Additionally, or alternatively, some embodiments may use the secondary root values 450 to derive a plurality of wallet keys. For example, an entity of the secondary root values 450 or a value derived from the entity may be transformed into a series of codewords that then used to derive a self-custody wallet seed via a BIP39 method. For example, some embodiments may apply Password-Based Key Derivation Function (PBKDF), such as PBKDF2, to the codewords in conjunction with an appropriate salt value and iteration value to determine a self-custody wallet seed. Some embodiments may then use the wallet seed to derive a plurality of deterministic wallet keys. For example, some embodiments may apply a BIP32 method using a self-custody wallet seed as an input to determine a wallet key associated with the wallet seed.

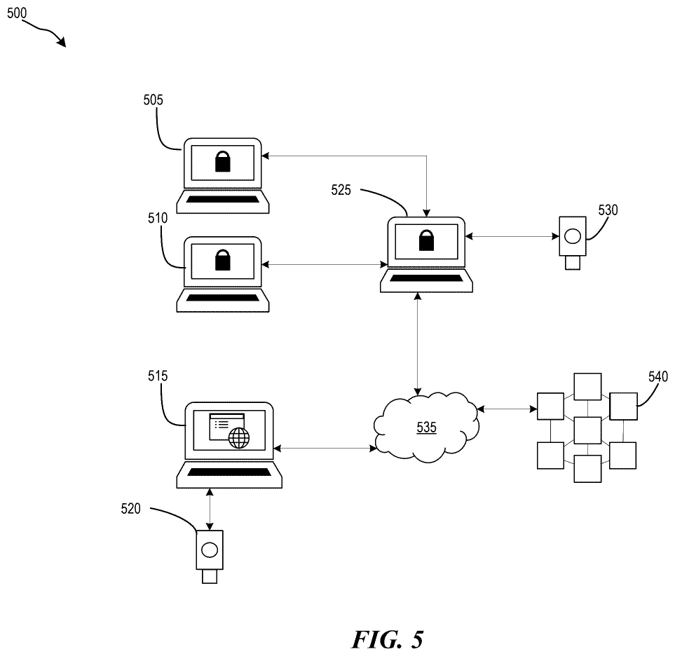

FIG. 5 shows an illustrative diagram for a noncustodial storage system 500, according to a plurality of embodiments. The noncustodial storage system 500 may comprise an initialization module 505, which may initialize a plurality of keys according to a key hierarchy 400. In one embodiment, the initialization module 505 may be implemented on an air-gapped machine (i.e., a machine not connected to the internet) to prevent unauthorized access to sensitive key material. In alternative embodiments, the initialization module 505 may be implemented on specialized hardware (such as an FPGA or ASIC, smartcards, HSMs, or alternative mechanisms for determining or managing secrets). The initialization module may also be made available via a service (i.e., an application programming interface (API) or web service), provided that sufficient controls are employed to prevent unauthorized access to sensitive key material.

The noncustodial storage system 500 may further comprise a client module 535, which may enable a client to interact with the system, such as by activating bundles and authorizing operations. The client module 535 may be a platform service, such as an API or web service accessible via a web browser. Additionally, or alternatively, the client module 535 may also be open-source software, such as a desktop application that may be run directly on client device 515 or may be implemented on specialized hardware or an air-gapped machine. The client module 535 may also interact with a decentralized network 540, such as a blockchain; according to one embodiment, client module 535 may transmit an authorized operation to a blockchain. The client module 535 may comprise a database component, which may store a plurality of objects or data that are employed in the noncustodial storage system 500—such as approval policies, operation keys, or fingerprints.

The client module 535 may be accessed by a client device 515, which may enable a client to interact with the system, such as by activating bundles, authorizing operations, or updating approval policies. The client device 515 may be any type of computing device such as a laptop computer, a server, a mobile device, or specialized hardware such as an FPGA or ASIC. The client device 515 may perform cryptographic operations involving the key hierarchy 400 locally, such as on a browser or using an open-source desktop application, in order to avoid transmitting sensitive material unencrypted over the internet. The client device 515 may also interact with a client key device 520, such as an HSM, smartcard, or other secure execution environment, which may store sensitive key material or perform cryptographic operations.

The noncustodial storage system 500 may further an operation execution module 510, which may enable a provider to execute operations in support of the client. For example, the operation execution module 510 may receive a root seed 410 and an encrypted child key and may use the same values to derive a secondary root value of the secondary root values 450, and further keys derived from the secondary root values 450 (such as asymmetric keypairs or self-custody wallet keys). The operation execution module 510 may also validate an approval policy, such as by verifying a plurality of cryptographic signatures provided by authorized representatives of the client or provider. The operation execution module 510 may then execute an operation, such as by signing an operation using a self-custody wallet key derived from the secondary root values 450. In one embodiment, the operation execution module 510 may be implemented on an air-gapped machine (i.e., a machine not connected to the internet) to prevent unauthorized access to sensitive key material. In alternative embodiments, the operation execution module 510 may be implemented on specialized hardware (such as an FPGA or ASIC, smartcards, HSMs, or alternative mechanisms for determining or managing secrets). The operation module may also be made available via a service (i.e., an API or web service), provided that sufficient controls are employed to prevent unauthorized access to sensitive key material.

The noncustodial storage system 500 may comprise a provider device 525 that may perform sensitive tasks in a secure execution environment. For example, the provider device 525 may retrieve operations that are ready for execution from the client module 535, provide those operations to the operation execution module 510 for execution, and then provide the executed operation to the client module 535 for further processing. The provider device 525 may also interact with keys, such as shard keys and shares that may be employed to recover the root seed 410, as well as operation keys. The provider device 525 may interact with a provider key device 530, such as an HSM, smartcard, or other secure execution environment, which may store sensitive key material or perform cryptographic operations (e.g., decrypting the encrypted child key with the operation key).

The modules, devices, and connections displayed in the figure are for illustrative purposes, and those skilled in the art will recognize a variety of alternative embodiments. For example, connections between modules and devices may represent networked connections (e.g., data transmitted over the internet or a local network), air-gapped connections (e.g., with data transmitted via flash drives or other storage media, with measures in place to validate the integrity, such as digital signatures), or physical connections on a specialized hardware device (such as an ASIC, FPGA, or HSM). Likewise, modules and devices may be implemented as platform services, APIs, workstations, instructions stored or executed on non-volatile memory, or other configurations that achieve a desired balance between operational convenience and security. Furthermore, when an embodiment attributes a step or feature to the noncustodial storage system 500 or a particular module or device, it is understood that this may correspond to any device or module described herein (e.g., provider device 525, client device 515, client module 535, initialization module 505, or operation execution module 510), unless the context indicates otherwise. For example, while the initialization module 505 is responsible for determining the key hierarchy 400 in one embodiment, the key hierarchy 400 may instead be determined by the client module 535 in other embodiments (e.g., if a client wishes to control the determination of key material). Many other such equivalent arrangements may be practiced.

As used herein, references to specific entities, such as “client” or “provider,” are provided only to delineate responsibilities according to an example embodiment. The entities may be, collectively or individually, individuals, corporations, DAOs, artificial intelligence agents, or any other entities that may practice any or all of the methods or systems described herein.

The noncustodial storage system 500 may comprise an initialization module 505 that may perform an initialization method to initialize a key hierarchy 400. Some embodiments may use the initialization method to configure cryptographic elements useful for the operation of the noncustodial digital storage system. For example, the initialization module 505 may determine entropy using a plurality of entropy sources (such as hardware and software random number generators), derive a plurality of keys or other sensitive values from said entropy according to a key hierarchy 400, and then distribute the sensitive values among a plurality of bundles. Bundles may then be distributed among a plurality of entities, such as clients or providers, thus dividing control of certain key material (without the client transferring custody of its digital assets to the provider). For example, bundles may comprise physical storage media (such as metal plates inscribed with key material), printed storage media (such as QR codes or other printed representations of key material), or key devices (such as HSMs, smartcards, Yubikeys, or other devices that may store or perform operations on keys).

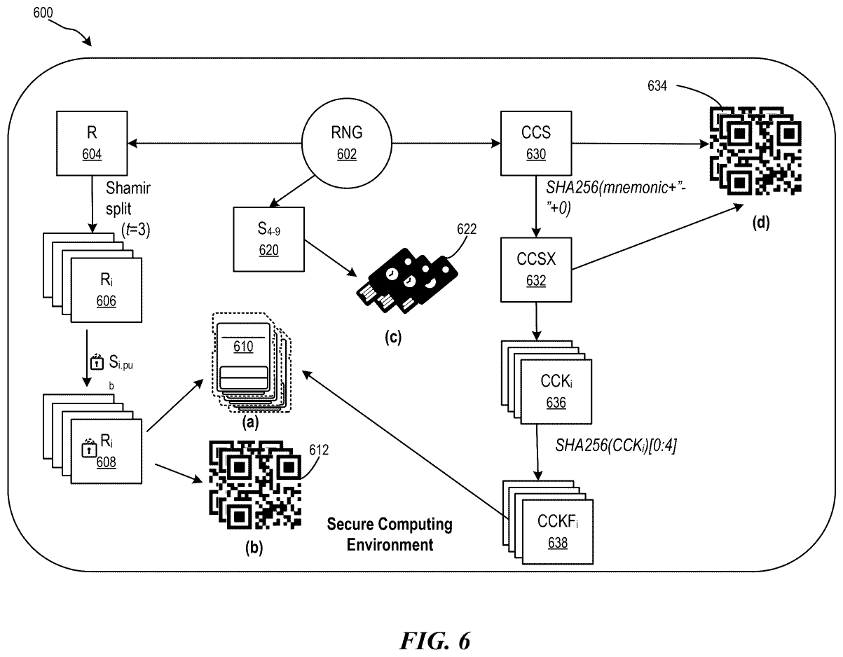

FIG. 6 shows an illustrative diagram for a data architecture 600 of a key hierarchy, in accordance with one or more embodiments. The data architecture 600 includes a physics-based random number generator 602 used to generate a root seed 604. Some embodiments may then perform a splitting algorithm to generate a set of root shares 606. Some embodiments may then encrypt each respective share into a respective shard to produce a set of root shards 608. The set of root shards 608 may then be stored into a set of SD cards 610 and encoded into a set of QR codes 612.

Some embodiments may also use the physics-based random number generator 602 to generate a client control seed 630. Some embodiments may then use the client control seed 630 as an input for an SHA-256 encryption algorithm in conjunction with an entity identifier value X to generate a first hash value and then use re-apply the SHA-256 encryption algorithm to the first hash value to obtain the child client control seed 632 for the entity mapped to the value X. Some embodiments may then generate a child control key 636 by using a combination of the child client control seed 632 as an input for a HMAC-SHA256 algorithm. Some embodiments may obtain a value from the child control key 636 (e.g., the first four digits, the first six digits, some other number of digits from some other position of the child control key 636) and use this value as an input for another hashing algorithm, such as SHA-256, to obtain the child control key fingerprint 638. Some embodiments may then store the child control key fingerprint 638 in the set of SD cards 610. Some embodiments may encode the client control seed 630 in a set of QR codes 634. Additionally, or alternatively, some embodiments may encode the child client control seed 632 in the set of QR codes 634.

Some embodiments may also use the physics-based random number generator 602 to generate a set of shards 620. Some embodiments may encrypt the set of root shares 606 to the set of shards 620 and store the resulting values in the hardware authentication devices 622. In some embodiments, a first set of the hardware authentication devices 622 may be sent to a noncustodial service provider and a second set of the hardware authentication devices 622 may be sent to a client or designated client representatives.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, while the client device 102 of FIG. 1 may be a head-mounted device, another type of mobile computing device may be possible. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. One or more non-transitory machine-readable media storing instructions may include instructions included on a single medium or instructions distributed across multiple media. For example, non-transitory media may act as one or more memory, where one or more memory may store program instructions that are written as source files or written in machine-executable program code. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include one or more relational databases. Alternatively, or additionally, the set of databases or other electronic storage used in this disclosure may include one or more non-relational databases.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storage may include one or more non-transitory machine-readable media (e.g., storage media) that electronically stored information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

Some embodiments may perform one or more operations described in this disclosure using an Application-Specific Integrated Circuit (ASIC). An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas, such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units, such as systolic arrays or tensor processing units (TPUs), can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints. Some embodiments may use a custom ASIC to execute a generation model, evaluation model, another machine learning model described in this disclosure. For example, a computer system may include or use a specialized ASIC possessing dedicated circuits for evaluating text and classifying parsed text (e.g., in the form of regular expression matching engines, hardware-based tokenizers, or specialized comparison units). The computer system may then use the dedicated circuits of this specialized ASIC to train or execute a machine learning model used to generate or evaluate text data.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some, or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device, such as a computer screen, and/or a dedicated input device, such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms, such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” the first item of a set of items may be “item 2” unless otherwise stated.

### Enumerated Embodiments

The present techniques will be better understood with reference to the following enumerated clauses:
1. A method comprising: generating a second seed and a secondary root value based on a first seed; determining a reconstructed version of the secondary root value based on an operation key associated with a received request; executing the action based on the reconstructed version.
2. A method comprising: generating a second seed based on a first seed; generating a first key based on the second seed; generating a secondary root value based on the first key and a root seed;
and executing an action by (1) reconstructing a reconstructed version of the secondary root value based on an operation key associated with a received request and a set of shards associated with the root seed and (2) executing the action based on the reconstructed version.
3. A method comprising: sharding a root seed using a secret sharing algorithm to generate a plurality of root seed shards of the root seed; cryptographically hashing a client control seed associated with a client to generate a child client control seed that is mapped to vault data comprising a vault seed and a vault key; generating a child client control key for an entity by executing a hash-based message authentication code operation based on the child client control seed; generating a secondary root value based on the child client control key and a version of the root seed; and in response to receiving a request to execute an action, executing the action for a distributed ledger by (1) reconstructing a reconstructed version of the secondary root value based on (i) an operation key associated with the entity and (ii) the plurality of root seed shards and (2) executing the action based on the reconstructed version of the secondary root value and the vault data.
4. A method comprising: generating a child client control seed based on a client control seed associated with a client; generating a child client control key by executing a message authentication code operation based on the child client control seed; generating a secondary root value based on the child client control key and a root seed; and executing an action by (1) reconstructing a reconstructed version of the secondary root value based on an operation key associated with a received request and a set of shards associated with the root seed and (2) executing the action based on the reconstructed version of the secondary root value.
5. The method of any of the embodiments described above, further comprising determining a first version of a secondary vault key based on the secondary root value, and wherein executing the action comprises: re-generating a second version of the secondary vault key based on the second version of the secondary root value; and executing the action based on the second version of the secondary vault key.
6. The method of any of the embodiments described above, wherein executing the message authentication code operation comprises: determining an intermediate value based on the child client control seed and an index associated with an entity associated with the child client control seed; and executing the message authentication code operation by inputting the intermediate value to a message authentication code function.
7. The method of any of the embodiments described above, wherein the set of shards is a first set of shards, further comprising: splitting the root seed into the first set of shards and a second set of shards by applying a secret sharing algorithm to the root seed; and storing the first set of shards in a set of physical key materials without storing the second set of shards in the set of physical key materials, wherein reconstructing the reconstructed version comprises reconstructing the reconstructed version based on at least two shards of the first set of shards.
8. The method of any of the embodiments described above, wherein executing the action comprises: executing the action on an air-gapped computing device; and uploading a result of the action on an internet-connected machine.
9. The method of any of the embodiments described above, further comprising: obtaining an operation identifier associated with the received request; selecting the operation key based on the operation identifier; retrieving a public key associated with the operation key based on the operation identifier; and obtaining, from a client device, a ciphertext constructed based on the child client control key and the operation key, wherein executing the action comprises executing the action based on the ciphertext.
10. The method of any of the embodiments described above, wherein generating the child client control seed comprises: determining a result indicating that a current count of child client control seeds does not exceed a threshold; and generating the child client control seed based on the result.
11. The method of any of the embodiments described above, wherein the operation key is a first operation key, further comprising: generating a plurality of operation keys; generating public keys of the plurality of operation keys; uploading a first public key to a database based on the public keys; obtaining a request; and retrieving the first operation key of the plurality of operation keys based on the request.
12. The method of any of the embodiments described above, further comprising: obtaining, from a client device, a previous operation request associated with a lost operation key; determining that the lost operation key is not in the plurality of operation keys; and sending a response to the client device indicating that the previous operation request is not executed.
13. The method of any of the embodiments described above, wherein retrieving the first operation key comprises retrieving the first operation key from a set of data stores, further comprising destroying the operation key in the set of data stores after executing the action.
14. The method of any of the embodiments described above, further comprising: obtaining ciphertext from a client device, wherein the ciphertext comprises an encrypted version of the second seed; generating a reconstructed root seed based on the set of shards retrieved from a set of servers; obtaining a decrypted version of the second seed by (1) decrypting an encrypted version of the operation key based on the reconstructed root seed and (2) decrypting the ciphertext based on a decrypted version of the operation key to obtain the second seed; determining the secondary root value based on the root seed and the second seed; and generating a secondary key based on the secondary root value, wherein executing the action comprises executing the action based on the secondary key.
15. The method of any of the embodiments described above, wherein generating the first key comprises constructing a child control key fingerprint based on the first key, further comprising providing the child control key fingerprint to a client device for client-side validation of child control keys constructed by the client device.
16. The method of any of the embodiments described above, wherein generating the second seed comprises: generating a first hash value by hashing the first seed; determining a result based on the first hash value and an index value mapped to an entity associated with the second seed; and generating the second seed by hashing the result.
17. A tangible, non-transitory, machine-readable medium storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for executing actions by providing operational access with child control keys generated from a hierarchy of cryptographic seeds, the system comprising:
one or more processors and media storing program code that, when executed by the one or more processors, causes operations comprising:
sharding a root seed using a secret sharing algorithm to generate a plurality of root seed shards of the root seed;
cryptographically hashing a client control seed associated with a client to generate a child client control seed that is mapped to vault data comprising a vault seed and a vault key;
generating a child client control key for an entity by executing a hash-based message authentication code operation based on the child client control seed;
generating a secondary root value based on the child client control key and a version of the root seed; and
in response to receiving a request to execute an action, executing the action for a distributed ledger by (1) reconstructing a reconstructed version of the secondary root value based on (i) an operation key associated with the entity and (ii) the plurality of root seed shards and (2) executing the action based on the reconstructed version of the secondary root value and the vault data.

2. A method for executing actions by providing operational access with child control keys generated from a hierarchy of cryptographic seeds, the method comprising:
generating a child client control seed based on a client control seed associated with a client;
generating a child client control key by executing a message authentication code operation based on the child client control seed;
generating a secondary root value based on the child client control key and a root seed; and
executing an action by (1) reconstructing a reconstructed version of the secondary root value based on an operation key associated with a received request and a set of shards associated with the root seed and (2) executing the action based on the reconstructed version of the secondary root value.

3. The method of claim 2, further comprising determining a first version of a secondary vault key based on the secondary root value, and wherein executing the action comprises:
re-generating a second version of the secondary vault key based on the second version of the secondary root value; and
executing the action based on the second version of the secondary vault key.

4. The method of claim 2, wherein executing the message authentication code operation comprises:
determining an intermediate value based on the child client control seed and an index associated with an entity associated with the child client control seed; and
executing the message authentication code operation by inputting the intermediate value to a message authentication code function.

5. The method of claim 2, wherein the set of shards is a first set of shards, further comprising:
splitting the root seed into the first set of shards and a second set of shards by applying a secret sharing algorithm to the root seed; and
storing the first set of shards in a set of physical key materials without storing the second set of shards in the set of physical key materials, wherein reconstructing the reconstructed version comprises reconstructing the reconstructed version based on at least two shards of the first set of shards.

6. The method of claim 2, wherein executing the action comprises:
executing the action on an air-gapped computing device; and
uploading a result of the action on an internet-connected machine.

7. The method of claim 2, further comprising:
obtaining an operation identifier associated with the received request;
selecting the operation key based on the operation identifier;
retrieving a public key associated with the operation key based on the operation identifier; and
obtaining, from a client device, a ciphertext constructed based on the child client control key and the operation key, wherein executing the action comprises executing the action based on the ciphertext.

8. The method of claim 2, wherein generating the child client control seed comprises:
determining a result indicating that a current count of child client control seeds does not exceed a threshold; and
generating the child client control seed based on the result.

9. The method of claim 2, wherein the operation key is a first operation key, further comprising:
generating a plurality of operation keys;
generating public keys of the plurality of operation keys;
uploading a first public key to a database based on the public keys;
obtaining a request; and
retrieving the first operation key of the plurality of operation keys based on the request.

10. The method of claim 9, further comprising:
obtaining, from a client device, a previous operation request associated with a lost operation key;
determining that the lost operation key is not in the plurality of operation keys; and
sending a response to the client device indicating that the previous operation request is not executed.

11. The method of claim 9, wherein retrieving the first operation key comprises retrieving the first operation key from a set of data stores, further comprising destroying the operation key in the set of data stores after executing the action.

12. One or more non-transitory, machine-readable media storing program code that, when executed by one or more processors, causes operations comprising:
generating a second seed based on a first seed;
generating a first key based on the second seed;
generating a secondary root value based on the first key and a root seed; and
executing an action by (1) reconstructing a reconstructed version of the secondary root value based on an operation key associated with a received request and a set of shards associated with the root seed and (2) executing the action based on the reconstructed version.

13. The one or more media of claim 12, the operations further comprising:
obtaining ciphertext from a client device, wherein the ciphertext comprises an encrypted version of the second seed;
generating a reconstructed root seed based on the set of shards retrieved from a set of servers;
obtaining a decrypted version of the second seed by (1) decrypting an encrypted version of the operation key based on the reconstructed root seed and (2) decrypting the ciphertext based on a decrypted version of the operation key to obtain the second seed;
determining the secondary root value based on the root seed and the second seed; and
generating a secondary key based on the secondary root value, wherein executing the action comprises executing the action based on the secondary key.

14. The one or more media of claim 12, wherein generating the first key comprises constructing a child control key fingerprint based on the first key, the operations further comprising providing the child control key fingerprint to a client device for client-side validation of child control keys constructed by the client device.

15. The one or more media of claim 12, wherein generating the second seed comprises:
generating a first hash value by hashing the first seed;
determining a result based on the first hash value and an index value mapped to an entity associated with the second seed; and
generating the second seed by hashing the result.

16. The one or more media of claim 12, wherein the secondary root value is a vault root, the operations further comprising determining a secondary vault key based on the secondary root value, and wherein executing the action comprises:
re-generating a second version of the secondary vault key based on the second version of the secondary root value; and
executing the action based on the second version of the secondary vault key.

17. The one or more media of claim 12, wherein generating the first key comprises:
determining an intermediate value based on the second seed and an index associated with an entity associated with the second seed; and
executing a message authentication code operation by inputting the intermediate value to a message authentication code function.

18. The one or more media of claim 12, wherein the set of shards is a first set of shards, the operations further comprising:
splitting the root seed into the first set of shards and a second set of shards by applying a secret sharing algorithm to the root seed; and
storing the first set of shards in a set of physical key materials without storing the second set of shards in the set of physical key materials, wherein reconstructing the reconstructed version comprises reconstructing the reconstructed version based on at least two shards of the first set of shards.

19. The one or more media of claim 12, the operations further comprising:
obtaining an operation identifier;
retrieving a public key associated with the operation key based on the operation identifier; and
obtaining, from a client device, a ciphertext constructed based on the first key and the operation key, wherein executing the action comprises executing the action based on the ciphertext.

20. The one or more media of claim 12, wherein the operation key is a first operation key, the operations further comprising:
generating a plurality of operation keys;
generating public keys of the plurality of operation keys;
uploading the public keys to a database;
obtaining a request; and
retrieving the first operation key of the plurality of operation keys based on the request.
